(19) United States
(12) Patent Application Publication
(10) Pub. No.: US 2007/0113253 A1
(43) Pub. Date: May 17, 2007

(54) ON-DEMAND SERVICE SYSTEM AND METHOD THEREOF BY APPLYING BROADCASTING

(75) Inventor: Ju Nan Chang, Taipei (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Inventec Appliances Corp.

(21) Appl. No.: 11/560,624

(22) Filed: Nov. 16, 2006

(30) Foreign Application Priority Data
Nov. 17, 2005 (TW) 094140502

(51) Int. Cl. H04N 7/173; H04N 5/445; G06F 13/00; G06F 3/00

(52) U.S. Cl. 725/86; 725/87; 725/61

(57) ABSTRACT

An on-demand service system is provided. The on-demand service system includes a positioning module providing a position information, a receiving unit receiving a digital broadcasting message, an input unit inputting an on-demand service command, a processing unit selecting a specific service information from the digital broadcasting message according to the position information and the on-demand service command, and an output unit outputting the service information.

### FIELD OF THE INVENTION

The present invention relates to an on-demand service system and the method thereof, and more particularly relates to an on-demand service system and method for providing an interactive and on-demand information service by applying unilateral broadcasting contents and messages incorporated with a satellite positioning system.

### BACKGROUND OF THE INVENTION

The so-called digital broadcasting system indicates the digital audio broadcasting (DAB) or the digital video broadcasting (DVB).

The digital audio broadcasting technology was opened up and developed in Germany since 1980. The digital audio broadcasting system is a broadcasting system after the AM and FM systems. In regard to the voice quality of the digital audio broadcasting system, the signal-to-noise ratio is over 95 dB and the bit rate is over 192 Kbps, which are better than the tone qualities of the most MP3 (MPEG audio layer 3). In addition, with some advantages, the digital audio broadcasting system has been widely applied. For example, the advantages of the digital audio broadcasting system include the ability of broadcasting the stereo program capable of transmitting 6 CDs simultaneously, the ability of transmitting the data information widely, the practicability of accomplishing a network with a single frequency by eliminating the pathway interference, and the ability of changing or recombining the studio program anytime and anywhere by the normal broadcasting system or the direct broadcast satellite system.

The digital video broadcasting system includes the digital video broadcasting-satellite (DVB-S), the digital video broadcasting-cable (DVB-C), digital video broadcasting-terrestrial (DVB-T) and digital video broadcasting-handheld (DVB-H). All the mentioned digital video broadcasting systems apply the MPEG-2 transport streams as their main transmission contents. In addition, it is possible to eliminate the noise and compress the signal so as to increase the transmission capacity, increase the utility rate of the channel, and provide the video image and sound effect with relatively high qualities via a digital broadcasting system.

Nevertheless, in the conventional broadcasting systems, such as the digital audio broadcasting system or the digital video broadcasting system, the broadcasting is always unilateral, and the user could only receive the unilaterally broadcasting information. Moreover, for the conventional broadcasting systems, it is impossible to provide an on-demand information service based on the respective demands of the user.

In order to satisfy the more and more demands, an on-demand service system and the method thereof are accordingly provided.

In view of the mentioned above, it is an object to provide an on-demand service system and method for providing an interactive and on-demand information service by applying unilateral broadcasting contents and messages and a satellite positioning system.

### SUMMARY OF THE INVENTION

In order to achieve the mentioned object, an on-demand service system is provided. The on-demand service system includes a positioning module for providing a position information, a receiving unit for receiving a digital broadcasting message provided by a digital broadcasting server, an input unit for inputting an on-demand service command, a processing unit for selecting a specific service information from the digital broadcasting message according to the position information and the on-demand service command, and an output unit for outputting the service information.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows a block diagram of the on-demand service system according to the present invention;

FIG. 2 shows a block diagram of the on-demand service system according to a preferred embodiment of the present invention;

FIG. 3 shows a flow chart of the method for performing an on-demand service according to a preferred embodiment of the present invention;

FIG. 4 shows a diagram of the on-demand service system according to a preferred embodiment of the present invention; and

FIG. 5 shows a diagram of inquiring the local parking information from the on-demand service system according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed. In addition, the same elements would be illustrated by the same reference numerals.

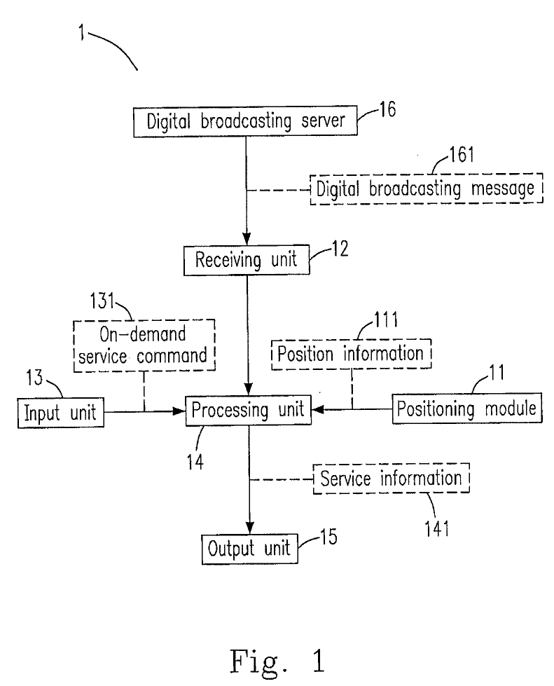

Please refer to FIG. 1, which shows a block diagram of the on-demand service system applying the broadcasting according to the present application. The on-demand service system 1 includes the positioning module 11, the receiving unit 12, the input unit 13, the processing unit 14 and the output unit 15. The positioning module 11 is used for providing a position information 111, the receiving unit 12 is used for receiving a digital broadcasting message 161 provided from the digital broadcasting server 16, and the input unit 13 is used to input an on-demand service command 131. The processing unit 14 is used for selecting a service information 141 corresponding to the position information 111 and the on-demand service command 131 from the digital broadcasting message 161 according to the position information 111 and the on-demand service command 131. The output unit 15 outputs the service information 141.

The digital broadcasting server 16 unilaterally broadcasts the digital broadcasting message 161. Preferably, the positioning module 11 is a satellite positioning system, the receiving unit 12 is ones of a digital audio broadcasting receiver and a digital video broadcasting receiver, and the output unit 15 could be a speaker.

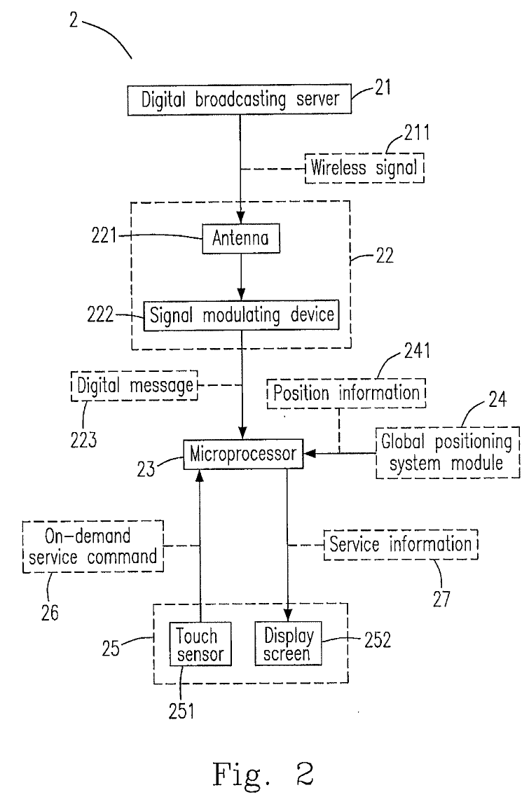

Please refer to FIG. 2, which shows a block diagram of the on-demand service system applying a broadcasting according to a preferred embodiment of the present application. The on-demand service system 2 includes the global positioning system module 24, the digital audio broadcasting receiver 22, the microprocessor 23, and the touch screen 25. The global positioning system module 24 provides a position information 241. The digital audio broadcasting receiver 22 is used for receiving a wireless signal 211 representing the digital broadcasting message provided by the digital broadcasting server 21. The digital audio broadcasting receiver 22 includes an antenna 221 and a signal modulating device 222. The antenna 221 is used to receive the wireless signal 211, and the signal modulating device 222 is used to transform the wireless signal 211 into a digital message 223. The touch screen 25 has an input function and an output function. The touch screen 25 includes a display screen 252 for outputting a service information 27 and a touch sensor 251 for user inputting an on-demand service command 26. The microprocessor 23 is used for selecting a service information 27 corresponding to the position information 241 and the on-demand service command 26 from the digital message 223 according to the position information 241 and the on-demand service command 26. In addition, the microprocessor 23 transmits the service information 27 to the display screen 252 for showing out.

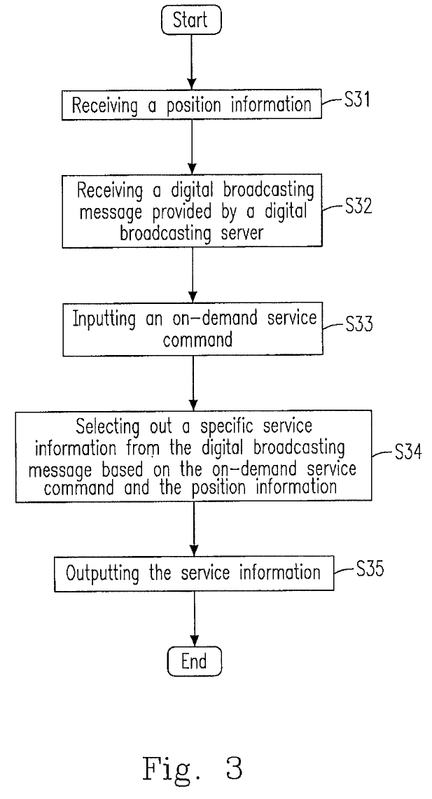

Please refer to FIG. 3, which is a diagram showing the flow chart of the method for performing the on-demand service according to the present application. The method includes the following steps: S31 receiving a position information, S32 receiving a digital broadcasting message provided by a digital broadcasting server, S33 inputting an on-demand service command, S34 selecting a service information corresponding to the position information and the on-demand service command from the digital broadcasting message according to the position information and the on-demand service command; and S35 outputting the service information.

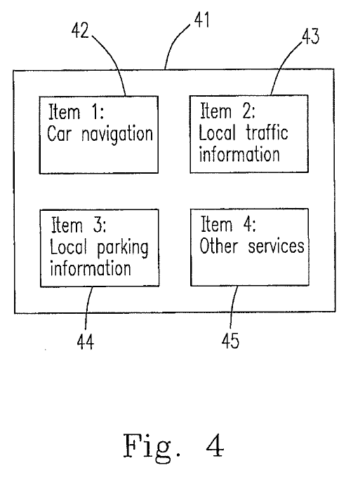

Please refer to FIG. 4, which shows a diagram of the on-demand service system according to a preferred embodiment of the present invention. As shown in FIG. 4, the main menu 41 of the on-demand service system includes four items, i.e. Item 1 car navigation, Item 2 local traffic information 43, Item 3 local parking information 44 and Item 4 other services. The user inputs an on-demand command from the input unit according to his desire. For example, when the user inputs an demand to select Item 3 local parking information 44, the processing unit of the on-demand service system would perform a comparison process for the digital broadcasting message received by the receiving unit to find out the relative parking information and then select out the corresponding local parking information based on the position information provide by a global positioning system. Then, the local parking information is outputted by the output unit.

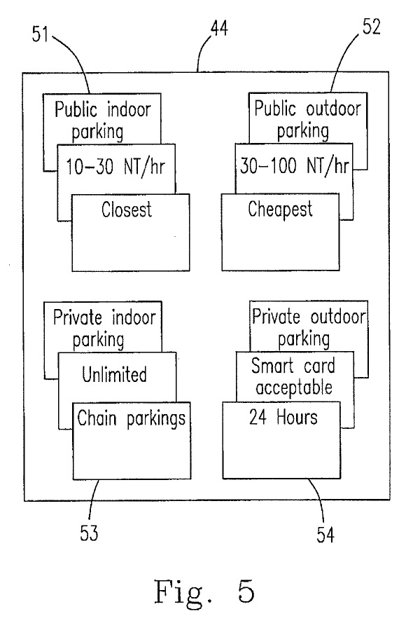

Please refer to FIG. 5, which shows a diagram of inquiring the local parking information from the on-demand service system according to a preferred embodiment of the present invention. FIG. 5 shows a service information under a situation that the user has inputted a demand for Item 3 local parking information. As shown in FIG. 5, the provided service information includes the public indoor parking 51, the public outdoor parking 52, the private indoor parking 53 and the private outdoor parking 54. As mentioned above, the on-demand service system and method according to the present application provide an interactive and on-demand information service by applying unilateral digital broadcasting messages and a satellite positioning system.

While the invention has been described in terms of what is presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An on-demand service broadcasting system, comprising:
a positioning module for providing a position information of a user;
a receiving unit for receiving a digital broadcasting message;
an input unit for inputting an on-demand service command of the user;
a processing unit for selecting a specific service information from the digital broadcasting message according to the position information and the on-demand service command; and
an output unit for outputting the specific service information.

2. An on-demand service system as claimed in claim 1, wherein the positioning module is a satellite positioning system.

3. An on-demand service system as claimed in claim 1, wherein the digital broadcasting message is provided by a digital broadcasting server.

4. An on-demand service system as claimed in claim 3, wherein the digital broadcasting server unilaterally broadcasts the digital broadcasting message.

5. An on-demand service system as claimed in claim 1, wherein the digital broadcasting message is a digital audio broadcasting message or a digital video broadcasting message.

6. An on-demand service system as claimed in claim 1, wherein the receiving unit is a digital audio broadcasting receiver or a digital video broadcasting receiver.

7. An on-demand service system as claimed in claim 1, wherein the input unit is a touch screen.

8. An on-demand service system as claimed in claim 1, wherein the output unit is a display screen or a speaker.

9. An on-demand service system as claimed in claim 1, wherein the specific service information is corresponding to the position information and the on-demand service command.

10. A method for performing an on-demand broadcasting service, comprising:
receiving a position information from a positioning module;
receiving a digital broadcasting message;
inputting an on-demand service command from a user;
selecting out a specific service information from the digital broadcasting message based on the on-demand service command and the position information; and
outputting the service information.

11. A method as claimed in claim 10, wherein the position information is provided by a positioning module.

12. A method as claimed in claim 11, wherein the positioning module is a global positioning system.

13. A method as claimed in claim 10, wherein the broadcasting message is provided by a digital broadcasting server.

14. A method as claimed in claim 13, wherein the digital broadcasting server unilaterally broadcasts the digital broadcasting message.

15. A method as claimed in claim 10, wherein the digital broadcasting message is a digital audio broadcasting message or a digital video broadcasting message.

16. A method as claimed in claim 10, wherein the position information is received by a receiving unit.

17. A method as claimed in claim 16, wherein the receiving unit is a digital audio broadcasting receiver or a digital video broadcasting receiver.

18. A method as claimed in claim 10, wherein the on-demand service command is inputted by a touch screen.

19. A method as claimed in claim 10, wherein the service information is outputted by an output unit being a display screen or a speaker.

20. A method as claimed in claim 10, wherein the specific service information is corresponding to the on-demand service command and the position information.
